(19) United States
(12) Patent Application Publication
(10) Pub. No.: US 2009/0076196 A1
(43) Pub. Date: Mar. 19, 2009

(54) Shaped particles from settable materials, manufacturing, composition, and composites

(76) Inventor: Hamid Hojaji, Las Vegas, NV (US)

Correspondence Address: HAMID HOJAJI, 1436 WATERTON DRIVE, LAS VEGAS, NV, 89144, US

(21) Appl. No.: 12/283,495

(22) Filed: Sep. 13, 2008

Related U.S. Application Data
(60) Provisional application No. 60/993,536, filed on Sep. 13, 2007.

(51) Int. Cl. C04B 14/30; B29B 9/00; C04B 12/02; C08K 3/30; C09D 1/00; C08K 3/32; C04B 7/02; C08K 3/22

(52) U.S. Cl. 524/2; 264/5; 427/446; 106/819; 106/713; 106/690

(57) ABSTRACT

A plurality of shaped particles that comprises at least one shaped early mechanically strong particle, the plurality of particles comprising a plurality of settable compounds, the shaped early mechanically strong particles being solid, porous, hollow, or a combination thereof, and being at least one of round and elongated.

### CROSS REFERENCE TO RELATED APPLICATIONS:

The present application claims the benefit of priority to Provisional Application Ser. No. 60/993,536, filed on Sep. 13, 2007.

### FIELD OF THE INVENTION

The present invention relates to shaped particles from settable materials, the manufacturing method thereof, composition thereof, and composites utilizing the shaped particles. The shaped particles are early mechanically strong and comprise settable compounds.

### BACKGROUND OF THE INVENTION

Inorganic particles are commonly used in composites to impart beneficial effects, such as lowering the composites density, modifying and improving rheology, strengthening the composites' structure, improving their economy of manufacturing, and many other physical and chemical property enhancements, and alterations.

One known method of making inorganic shaped particles is by solidifying a liquid or semi-liquid precursor material into shaped particles, for example, by processing molten glass and molten ceramic like materials into hardened particles. Another method of making shaped particles is by first forming the shaped particles from a precursor material, such as gels and slurries, followed by one or a combination of various thermal processes, such as drying, sintering, and melting.

The above mentioned methods, even though well developed and currently practiced, suffer from major drawbacks. Melting requires high temperature processing which involves high energy consumption, complex safety measures and operational setups. High energy consumption translates into higher greenhouse gas emission levels into the environment, thus contributing to the global warming. Energy intensive products have a substantial carbon foot print, measured in units of carbon dioxide per unit of product. Forming the shaped particles from liquid or gel precursors followed by drying, sintering or melting suffers from at least the same drawbacks mentioned in connection with melting. Drying alone represents evaporation of substantial amounts of water per unit of product produced, thus requiring significant amounts of energy, which again result in increased emission of greenhouse gases into the environment.

In view of aforementioned drawbacks, there remains a need for shaped particles suitable for use in composite materials, that are highly strong, have low carbon foot print, are low energy intensive to manufacture, and are easy to produce. In addition, such particles are environmentally friendly, and chemically stable.

Since there is a strong desire and urgency from the world communities to mitigate emission of greenhouse gases through the development of alternative products, processing methods and formulations for manufactured products, shaped “green” particles with low carbon foot print are highly desirable for high performance composites.

### SUMMARY OF THE INVENTION

With the invention described therein, one or more disadvantages associated with currently known shaped particles, their formulations, and methods of manufacture are overcome. In addition, useful alternatives for such conventionally shaped particles and methods of manufacture are also proposed. Pursuant to studies being made to eliminate some of the drawbacks such as complexity of manufacturing, and high levels of green gas emission, while maintaining the beneficial effects of the shaped particles, the objects of the present invention have become apparent.

Therefore, in accordance with the present invention, a plurality of shaped particles is provided, that comprises at least one shaped early mechanically strong particle, the plurality of particles comprising a plurality of settable compounds. The shaped early mechanically strong particles are one of solid, porous, hollow, or a combination thereof. The early mechanically strong particles are one of round and elongated. The plurality of settable compounds comprises at least a rapid set compound and may comprise a combination of two distinct components.

In accordance with the present invention at least a method of manufacturing a plurality of shaped particles is provided. The method comprises forming a liquid precursor comprising at least one settable compound, and processing the liquid precursor into a plurality of shaped particles. In accordance with the method of the present invention, the liquid precursor is at least one of a solution, a paste, slurry, a suspension, a gel, and a combination thereof, and may be an aqueous solution, a non-aqueous solution, and a combination thereof. In accordance with an embodiment of the present invention, the method further comprises setting the at least one settable compound by a chemical reaction, crystallization, hydration, physical combination, gelation, dehydration, drying, and a combination thereof. The setting of the settable compound occurs prior, during, and post forming the processing of the liquid precursor into the plurality of shaped particles. Post processing steps of the plurality of shaped particles may be employed. In accordance with a further embodiment of the present invention, the one settable compound is a rapid setting compound elected from a plurality comprising at least one of magnesium containing compound, phosphate containing compound, calcium containing compound, aluminate containing compound, alkali activated alumino silicate containing compound, and calcium sulfo-aluminate containing compound. The setting processing of the present invention requires low to negative energy input. The processing of the present invention is one of thermal spraying, spray drying, pelletizing, extruding, fluidizing, and pulverizing a bulk of settable compound.

By practicing the methods of the present invention, novel shaped particles manufactured from liquid precursors are provided. The liquid precursor according to an embodiment of the method of the present invention comprises components of at least one settable compound that is converted into the shaped particles. The setting of the settable compound is achieved by one or a plurality of chemical reactions, crystallization, hydration, physical combination, gelatin, dehydration, and drying, wherein the components of at least one settable compound in the liquid precursor are fully or partially combined, and formed into shaped particles. According to an embodiment of the method of the present invention, the setting of the components of the settable compound requires low amount of energy input and the setting process may be exothermic, thus requiring zero energy input. The settable compound of the present invention is shaped into shaped particles by low carbon foot print processing methods. The liquid precursor contains components of a settable compound that combine to form the settable compound and subsequently form into the shaped particles. Setting of the settable compound may take place wholly or concurrently before, during, and post forming process into the shaped particles. The settable compounds according to an embodiment of the method of the invention comprise components of one or a plurality of rapid set compounds that result in development of high early strength in the shaped particles.

In accordance with the present invention, a composition for the plurality of shaped particles is also provided. The composition comprises at least one settable compound in a liquid medium. The present invention further provides the composition for the components of the settable compounds from at least one of a chemical form of alkaline earth metals, of phosphates, of chlorides, of sulfates, of silicates, of aluminates, of alumino silicate, of alumina, of alkali metals, water, and a combination thereof. The elected components, when combined form rapid setting compounds, develop early strength upon setting into a solid form. Early strength is understood at least as compressive, hydrostatic, or crushing strength. The terms “compound” and “cement” are and might be been used interchangeably throughout the present document. In accordance with a further embodiment of the present invention, insofar the composition, the plurality of shaped particles have fillers, such as waste byproducts.

In accordance with the present invention at least a composite material is provided. The composite materials in accordance with the present invention comprise in their make-up a plurality of early strength novel shaped particles. The composite material in accordance with an aspect of the present invention possesses improved physical, chemical, and environmental performance. The composite is at least one of a building product, a polymeric product, a cementitious product, a cement slurry, a paint, and a coating, wherein the addition of early strength novel shaped particles has improved its specific strength, manufacturing efficiency, and service performance.

In particular, the present invention provides for shaped particles that utilize in their composition waste byproducts that make them environmentally friendly and green. In yet another aspect of the invention, the shaped particles are formed by low energy demanding processing methods, taking advantage of the low to negative energy input required for setting the components into settable compound forming the shaped particles. By negative energy input is understood an exothermic reaction between the components of the settable compound, that generates heat. An important advantage of the present invention is related to the density modification of composites that utilize the inventive shaped particles that are hollow or porous. The shaped particles according to the present invention are chemically stable and can be used in building materials to lower weight, yet do not cause chemical and physical degradation of the resulting building materials.

### BRIEF DESCRIPTION OF THE DRAWINGS

For a more complete understanding of the features and advantages of the present invention, reference is now made to a description of the invention along with accompanying figures, wherein:

FIG. 1 represents a flowchart of a method of manufacturing a plurality of shaped particles, in accordance with the present invention.

FIG. 2 represents a flowchart of a first exemplary method of manufacturing a plurality of shaped particles shaped particles, in accordance with an aspect of the present invention.

FIG. 3 represents a flowchart of a first exemplary composite formation method, in accordance with another aspect of the present invention.

Like numerals in the drawings referenced above indicate identical elements or steps.

### DETAILED DESCRIPTION OF INVENTION

Although making and using various embodiments are discussed in detail bellow, it should be appreciated that the present invention provides many inventive concepts that may be embodied in a variety of contexts. The specific aspects and embodiments discussed therein are merely illustrative of ways to make and use the invention, and do not limit the scope of the invention.

As used therein, the term settable compound and the term settable materials have the same meaning and are used interchangeably through the present document. The term “filler” is a broad term and shall have its ordinary meaning and shall include without limitation any materials added to the precursor containing components of the settable compound from which the shaped particles are formed. Settable compound according to the present invention sets from a liquid state to the solid state which is further referred to as setting reaction. A setting reaction may include drying as an integral part of the process to form shaped particles. A liquid state according to the definition of the present invention comprises slurries, solutions, suspensions, pastes, mud, gels, foams, emulsions, gas-liquid mixtures, and any other physical form that is not completely solid. From hereafter, the terms “particles”, “shaped particles”, “particle fillers”, and “hardened particles” are used interchangeably in this document. Further, the terms “additives” and “filler materials” are used interchangeably in this document. Further yet, the terms “liquid precursor”, “precursor” “liquid precursor components of the settable compound containing”, “cement slurries” and “cementitious liquids” are used interchangeably in the present document.

One or more embodiments of the present invention provide shaped particles that incorporate a novel combination of functional building blocks.

Such inorganic shaped particles are solid, porous, foamed, and hollow. Their porosity can be opened, closed, and a combination thereof. The hollow shaped particles have additional opened and closed porosity in their separatory walls. The porous and the hollow shaped particles contain at least one void.

The shaped particles have one of the plurality of shapes, such as round, semi-round, fibrous, plate like, jagged, etc. Particular forms for the shaped particles are elongated, flat, round, and spherical shapes. The elongated shapes are fibers, tubes, and cylinders. The flat/sheet forms are for example plates and flakes. The round shapes are either regular or irregular. The round regular particles are either spherical or have near spherical shapes. All these variations of shape are considered to be incorporated under the broader encompassing term of “shaped particles” and will be made reference to specifically only when addressing specific challenges that pertain to their shape.

In preferred embodiments for the present invention, round shaped particles have average diameters of less than 100 mm; the sheet like particles have a cross section to thickness aspect ratio of 10 to 1000; and the elongated particles have length to cross sectional aspect ratio of 2 to 2000. The preferred round particles have an average diameter of less than 5000 microns and greater than 1 micron.

In one preferred embodiment for the present invention, the shaped particles are porous or hollow, having an average particle diameter between 1000 microns and 5 microns. In another preferred embodiment, the round particles have an average spherecity greater than 0.6, preferably greater than 0.75, and most preferably greater than 0.9.

The density of the novel shaped particles differs from the density of shaped settable compound with no substantial porosity, which is normally greater than 2 g/cc. In a preferred embodiment, the shaped particle density is within the range of 2 g/cc to 0.1 g/cc, more preferably from 1 g/cc to 0.1 g/cc. The particle density is also referred to as the apparent density of particles.

In a preferred embodiment of the present invention, the shaped particles have spherecity greater than 0.9 and are foamed, porous, or hollow. In the most preferred embodiment of the present invention, the particles are substantially hollow with a large central void, and a substantially solid exterior wall, with or without porosity, a particles' density in the range of 0.8 to 0.2 g/cc, and an average particles diameter in the range of 5 microns to 500 microns.

The shaped particles of the present invention, described therein, incorporate a novel combination of functional blocks to make them more effective in the composites they are part of. The functional blocks are attached to the surface of the shaped particles to impart hydrophobic, hydrophilic, pH control, bonding, catalytic activity, accelerating and retarding activities, color, specific coating functionality, rheology, and other known functional activities. Specific coating functionality contemplated for the shaped particles of the present invention includes, but is not limited to electrical, magnetic, optical, bio active, radioactive, metallic, controlled permeability, and the like. The functional blocks are preferably applied during the formation, or post formation of the shaped particles.

Said settable compounds from which the shaped particles are made of comprise at least one of a plurality of a rapid setting compound in a liquid precursor. The liquid phase of the liquid precursor is at least one of aqueous, non aqueous, and a combination thereof. According to the present invention, said plurality of rapid setting compound comprises at least a combination of two distinct components. The distinct components include components of the settable compounds, filler materials, and the liquid phase of the liquid precursor from which the shaped particles are made. For example the combination in one embodiment of the present invention comprises a rapid set compound and water, such as an alkali activated alumina silicate cement and water. In another example, it comprises a calcium sulfo-aluminate cement and water. In yet another example, it comprises a magnesium chloride solution as one component and magnesium oxide as the second component of an appropriate liquid precursor. Further yet, in another example, an alkali phosphate water mixture is the first component and magnesium oxide is the second component of another appropriate liquid precursor according to the present invention. According to a preferred embodiment of the present invention, the composition of the components of the settable compound comprises at least one of a compound of an alkaline earth element, a compound of phosphate, a compound of chloride, a compound of sulfate, a compound of silicate, a compound of aluminate, a compound of alumino silicate, a compound of alumina, a compound of an alkali metal, and a combination thereof. Water is also considered to be a component of the settable compound in the presence of at least one the components listed above. Exemplary alkaline earth elements are magnesium, calcium, strontium, and barium, and mist, preferably magnesium and calcium. The preferred alkali metals are lithium, sodium and potassium. Other divalent metals such as zinc and copper may replace part or all of the divalent alkaline metals in some special cases. On the other hand poly atomic ammonium cation can replace part of or all of the alkali metal in the components of the settable compounds.

The liquid precursor takes various physical forms including solutions, slurries, liquids, suspensions, pastes and gels. They are prepared from at least one or a combination of rapid setting settable compounds. Such settable compounds comprise magnesium comprising cements or compounds, phosphate containing cements or compounds, calcium containing cements or compounds, aluminate containing cements or compounds, pozzolanic or pozzolans containing cements or compounds, alkali activated alumino silicate cements or compounds, and calcium sulfo-aluminate containing cements or compounds. Preferably, the components of the settable compounds are combined rapidly to develop shaped particles with early mechanical strength. As a result, the shaped particles according to the present invention are early mechanically strong and maintain their shapes and forms upon exiting the processing equipment. Consequently, the newly formed shaped particles can be easily handled during transfer, storage, and further use, and are expected to withstand fragmentation and mechanical stresses.

Magnesium comprising cements include at least one of the magnesium oxychloride, and magnesium oxysulfate cements, and a combination thereof. Phosphate containing cements include at least one of magnesium phosphate, calcium phosphate cements, and a combination thereof. Additional phosphate components may be used to control the setting and performance of the cements, such as aluminum phosphate, iron phosphate, and other phosphate salts. Zinc and calcium can partially or wholly replace magnesium in oxy-chloride and phosphate cements. Aluminum phosphate may be added to the magnesium oxychloride to control the set time and improve the water permeability. In the case of magnesium oxychloride cementitious mixtures, the resulting crystallized phases have compositions of 3MgO.MgCl2.11 H2O, and 5MgO.MgCl2. 8 H2O or combinations thereof.

Rapid setting calcium sulfo-aluminate cement may be blended with other cement additives and admixtures to control the set time and performance, strength and durability, of the resulting shaped particles. For example, hydraulic cements such as variations and components of Portland cement may be added to calcium sulfo-aluminate. In another embodiment, calcium sulfo-aluminate cements may replace wholly or partially the magnesium cement. Still in another embodiment, alkali activated alumino-silicates may partially replace the magnesium cement. The alumino-silicates comprise a variety of natural, manufactured, byproducts, and waste products, such as clays, minerals, rocks, fly ash, bottom ash, slags, waste glass, kiln dust, mining wastes, and alike. Silica or silicates may be used as well instead of alumino-silicates.

Thus, a preferred liquid precursor for the present invention comprises components of settable compounds of at least one of the following settable components: magnesium oxychloride based, magnesium oxysulfate based, phosphate based, aluminate based, calcium based, calcium sulfo-aluminate based, pozzolanic based, and optionally alkali activated alumino-silicate based compounds. The liquid precursor containing the components above is at fluidity stage that can be shaped into particles. This applies to precursors that have the consistency of stiff mud at one end of the spectrum to the very fluid state at the other end of spectrum, and anything in between

Blending various additives with the above mentioned rapid setting cements improves the durability of the resultant shaped particles against water ingress and freeze-thaw damage. For instance, blending aluminum phosphate and magnesium oxychloride decreases the water ingress of the resulting shaped particle. The addition of magnesium phosphate leads to the adjustment of the set time of magnesium oxychloride. The addition of additives/filler materials to the cementitious mixture improves one or all of the physical, chemical, rheological, hardening, and cost reduction characteristics of the cementitious mixture. Other properties not mentioned here are also subject to improvement and positive change.

Filler materials are finely ground powders of minerals, oxides, pigments, colorants, organic and inorganic liquids, solids, and alike. Examples of such inorganic filler materials are finely ground siliceous materials, clays, rocks, carbonates, sulfates, ash, fly ash, bottom ash, sludge, mud, slag, kiln dust, glass, ceramics, silica dust, fumed silica, and rice hull ash. An example of organic filler material is a polyurethane compound. Cementitious materials can also be used as fillers. One example is Portland cement powders, either before hydration or after hydration and further size reduction. Fibers may also be added to the cementitious mixtures to reinforce the shaped particles.

Active filler compounds can also be added to aid in achieving the desired functionality of the shaped particles in composite applications. Functional filler materials that impart specific functionality to the shaped particles may be added directly to the precursor, during the formation of the shaped particles, or after the formation of shaped particles. The functionality enhancement may be physical in nature, chemical in nature, or a combination thereof. For example, magnetic filler materials can be added to impart magnetic functionality to the shaped particles. Examples of such magnetic fillers are magnetite filler powders. Electronic filler materials can alter the electrical properties of the shaped particles, when added as fillers. Examples of such fillers are dielectric filler powders, such as, titanates, conducting filler powders such as silver or gold, conductive organic filler materials, etc. Filler powders that can impart specific catalytic functionality can also be added which in turn produces shaped particles

Pigments, colorants and optically altering filler materials may also be added, directly to the precursor, during the formation of the shaped particles, or after the formation of shaped particles to impart colors or optical functionality to the shaped particles. Examples of such filler materials are various organic and inorganic colorants in solid or liquid form, and fluorescent filler compounds that impart florescent functionality to the shaped particles for applications such as use in road signs, etc. Other potential filler materials are anti fungus and biocide chemicals that impart anti fungal properties to the shaped particles. Other functional filler materials that are known to the person skilled in the art can be added to the cementitious mixture and become a part of the shaped particles to which the intended functionality is inherited.

The novel shaped particles of the present invention have envisioned utility also in stabilizing and solidifying toxic materials including hazardous and nuclear waste materials. The toxic materials in the form of powders, slurries, solutions or the combination thereof may be added as filler materials to the precursor and thereby become an integral part of the shaped particles. The shaped particles in this case become a stabilized waste form that can be stored or safely disposed of.

The precursor comprising a mixture of all or a part of the functional building blocks described above, whether or not the mixture is realized by a one step or subsequent addition and mixture steps, is processed into shaped particles by spraying, blowing, pelletizing, pressing, fluidizing, extrusion, or by utilizing other techniques that may become apparent to the persons skilled with the methods of formation of shaped particles from slurries, solutions, suspensions, pastes, mud, gels, foams, emulsions, gas-liquid mixtures, and any other physical form or state that is not completely solid. The resulting shaped particles according to the inventive embodiments of the present invention may be solid or containing voids. The solid shaped particles do not containing pre-designed porosity and are substantially free of voids. Alternatively, light weight particles are foamed or hollow shaped particles that contain voids, pores, gas pockets of various concentrations, and shapes which may be open or closed. The bulk density of such light weight particles is preferably less than 1.5 g/cc. In one embodiment, the precursor containing the components of the settable compound is allowed to harden into a solid mass, wherein the solid mass is then pulverized into shaped particles.

In one embodiment where solid shaped particles are obtained by practicing the present invention, the liquid precursor containing the components of the settable compound does not contain foaming or blowing or gas forming agents. If desired, certain admixtures may be added to lower the surface tension and de-foam the liquid precursor before and during the formation of shaped particles. If light weight shaped particles are desired, the liquid precursor according to the method of the present invention contains at least one foaming, blowing, or gas forming agent. The term “foaming agent” includes blowing agents, surfactants, and gas forming agents. The foaming agent can be activated prior to the formation of shaped particles, during the formation of shaped particles, after formation of the shaped particles, or combination thereof. The shaped particles obtained in accordance with the present invention preferably have an average size less than 10 mm. The light weight shaped particles are foamed, porous or hollow may have multitude of micro, macro, open and closed porosities within one particle with an average size preferably less than 10 mm. In the case of round particles, the average diameter is preferably less than 10 mm. It should be noted that the present invention is not limiting the average size of the shaped particles to not more than 10 mm.

Several modalities of addition of foaming agents are contemplated to cause the formation of gas bubbles by physical or chemical affects. They can be pre-blended with the components of the settable compound prior to the formation of the liquid precursor. In another embodiment, they can be added directly to the liquid precursor before the formation of shaped particles. In yet another embodiment the foaming agents can be added to the liquid phase of the liquid precursor before the addition of solid components. And yet in another embodiment, the foaming agents can be added at any time during the preparation of the liquid precursor. In another embodiment, the foaming agent may be added during the transport of the liquid precursor to the particle forming equipment. The foaming agent may be activated in the liquid precursor, during storage of the liquid precursor, during the transport of the liquid precursor to the forming equipment, during the formation of the shaped particles, and after the formation of the shaped particles. In one embodiment, the liquid precursor is foamed by adding a foaming agent such as hydrolyzed protein, and subsequently aerated by mechanical agitation. Instead of hydrolyzed protein or in addition to it, organic foaming agents and various air-entraining admixtures may also be used to foam the precursor mixtures and the resulting shaped particles.

The foaming agents contemplated to be used in the present invention include but are not limited to the following foaming admixtures: saponin, which is a natural foaming agent that is water soluble and can be pre-blended with the solid components of the settable compound, additives, or combination thereof before the formation of the final precursor. It also can be added to the liquid portion of the precursor before addition of solid components, or added to the liquid precursor prior to the particle forming process. One source of saponin is the Quillaia extract which is a natural GRAS (generally recognized as safe) food-grade surfactant ingredient rich in saponins and sapogenins. Quillaia extract powder is used to formulate liquid soaps without artificial saponification of fats or vegetable oils. Another foaming agent is an aqueous concentrate of a surface-active Polypeptide-Alkylene polyol condensate which can be formulated to yield tough, stable, voluminous micro bubbled foamed precursor mixture. Other foaming agents are powdered metals such as magnesium, zinc, aluminum, etc. which upon addition to the produce hydrogen gas, thus forming micro-sized bubbles. Surfactants can be subsequently used to stabilize the foamed precursor mixture. Examples of such surfactants are cocoamine betaine, polyethoxy ethanol, ethyleneoxy ethanol, fatty alcohol sulfate, etc.

Other classes of suitable foaming agents that are water soluble are polycarboxylates and polyoxyethylene poly carboxylate. Lactic acid is very efficient surfactant in cementitious systems including rapid set cementitious systems. Yet another foaming agent is a synthetic liquid anionic concentrate formulated from butoxyethanol. (CELLFLOW made by Berolan Vertriebsgesellschaft m.b.H. Germany). Addition of bitumen emulsion additives below 10 wt % helps the strength and water tightness of the shaped particles. It also improves the rheology of the liquid precursor for subsequent spray drying and other particle formation processes.

The aerated foam is obtained by mechanically agitating a foaming agent within the slurry that is either a hydrolyzed protein or a synthetic chemical. Water is used to dilute the foaming agent; the ratio of water to agent is exemplarily 40:1 for protein, and 25:1 for synthetic chemicals. Air-entraining admixtures may also be used, at dosages between 0.4 and 0.7% by mass of settable compound. Subsequently the surfactants can be added to stabilize the foam; one commonly used surfactant is sodium coco-sulfate. Water content of the liquid precursor preferably is less than 60% by weight, and more preferably less than 40%, and most preferably less than 30%. Lower water content in liquid precursor requires less energy to dry, and in most cases produces stronger shaped particles.

The shaped particles are manufactured from either one of a plurality of precursors discussed above, by either one or combination of the following processes of spraying, blowing, pelletizing, pressing, fluidizing, extrusion, or by utilizing other techniques that may become apparent to the persons skilled with the methods of formation of shaped particles from slurries, solutions, suspensions, pastes, mud, gels, foams, emulsions, gas-liquid mixtures, etc.

Preferred methods of manufacture are thermal spraying such as spray drying and aerosol formation through spray nozzles into a heated chamber. In one preferred embodiment for the method of the present invention, the liquid precursor is transferred under pressure through spray nozzles into a heated chamber, thereby forming droplets that upon solidification form shaped particles. In another preferred embodiment, the pre-foamed liquid precursor is transferred under pressure through spay nozzles into a heated chamber, thereby forming gas entrained droplets that upon solidification form light weight shaped particles. Yet in another preferred embodiment, the liquid precursor with the foaming agents are transferred under pressure through spray nozzles into a heated chamber, thereby foaming agent is activated, forming foamed droplets than upon solidification form light weight shaped particles. In another preferred embodiment, the liquid precursor is transferred under pressure into a mixing cavity or an in-line mixer and mixed with a stream of foaming agent, and the resulting mixture is sprayed through spray nozzles into a heated chamber, thereby forming foamed droplets that upon solidification form light weight shaped particles. Yet in another preferred embodiment, components of the settable compound may be delivered individually from separate sources into a common location right before the particle shaping process taking place to minimize the residence time that the components are in contact with each other. The components of the settable compound include the foaming agent as well. The common location includes but not limited to a high intensity inline mixing chamber, an inline mixer, a pressurized mixing chamber, and alike. This method in particular is very useful when the components are very reactive with each other and thus tend to form the settable compound in a short period of time which may interfere with the transport of the liquid precursor to the particle processing equipment. The interference may be in the form of premature solidification, excessive heat generation, excessive gas formation, degassing of the foaming agent, contamination, deactivation, change in flow properties, and other undesired events that may occur before reaching the particle formation processing equipment. In one example of the present invention, it is highly desirable to add radioactive component through a separate line into an inline mixer and not contamination the front end of the manufacturing equipment. This applies to the foaming agent that upon introduction to the liquid precursor rapidly produces gas that may escape the system if left idle in an open mixing tank upstream from the particle forming process. The atmosphere inside the particle forming processing unit may be controlled for the best possible outcome. The major control variables include temperature, pressure, relative humidity, and ambient or atmospheric gas composition. For example in a thermal spraying chamber both temperature and pressure should be regulated for the best results, including excellent quality of the shaped particles at a high production throughput. In another example of the present invention steam, CO2, or a combination thereof can be injected into the chamber of the processing unit to increase the concentration of water vapor, and CO2 in the gaseous phase to assist in hardening by hydration, or carbonation or combination thereof. Optionally, the heated chamber may be pressurized with steam or other gases to enhance the setting, solidification, or combination thereof. Further, the heated chamber may be operated under reduced pressure to facilitate the solidification process. Further, the chamber may operate at ambient temperature to save energy. Further still, the chamber or the precursor may need to be cooled below ambient temperature to control the setting of the settable compound and foaming process. In general, the shaped particles are formed by low energy demanding processing methods taking advantage of low to negative energy input required for setting of components into settable compound forming the shaped particles. Negative energy input is referred to an exothermic reaction between the components of the settable compound that generates heat. In some cases the heat generated by exothermic reaction may need to be removed to control the set time during the processing and manufacturing of the shaped particles.

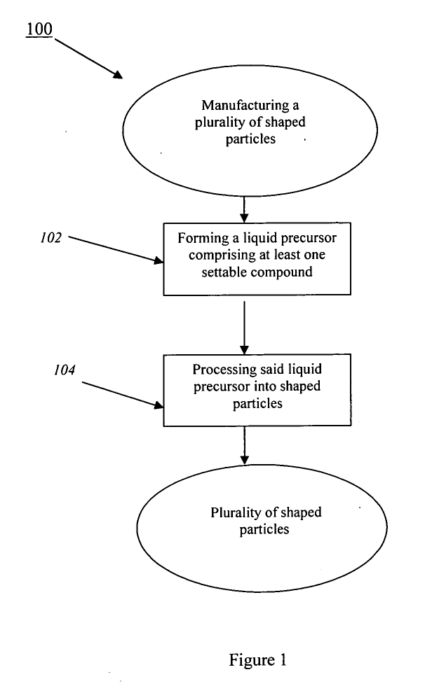

FIG. 1 represents a flowchart of a method of manufacturing a plurality of shaped particles, in accordance with the present invention.

The manufacturing method 100 of a plurality of shaped particles comprises at least a forming step 102 and a processing step 104 to arrive at the plurality of shaped particles. During forming step 102 of a liquid precursor comprising at least one settable compound, a liquid precursor is fed into a particle forming equipment. Preferably the liquid precursor is thoroughly homogenized before entering the particle formation equipment. In subsequent step 104, the processing of a liquid precursor, a pump, or a similar device such as positive displacement equipment is employed to deliver the liquid precursor into the particle forming equipment 106. The liquid precursor may also be fed by gravity into the particle forming equipment 106. A variety of pumps may be employed in step 104, depending on the viscosity and flow behavior of the liquid precursor. For example, if the liquid precursor is highly heat sensitive, then a progressive cavity pump may not be appropriate since it generates heat during the pumping action. Whereas a peristaltic pump or piston pump may be more appropriate, since not as much as heat is generated. Heat sensitivity of the liquid precursor can be due to how fast the settable compound sets. Premature setting in the transfer lines, before the particle forming process will cause clogging of the lines and consequently delay in production, and hence is not desirable. In some cases when the heat sensitivity is extremely high, the transfer lines may be externally cooled by appropriate means, such as air or water cooling. Optionally set retarders may be used to delay the set time of the settable compounds. In addition, the liquid precursor formed in step 102 may be cooled before step 104 to delay the set time, as another option.

The particle forming unit 106 according to the present invention can be any of the multitudes of commercially available particle forming equipment or specifically designed for this application. Examples of commercially available equipment are sprayers, pelletizers, pressure and rotary atomizers, and alike. Spray dryers with either pressure nozzles or rotary atomizers are relatively simple to operate and readily available in different designs for different applications. Heat can be supplied if needed by means of hot air or steam. The liquid precursor is pumped through the atomizing nozzles, where droplets with controlled size and shape are formed and rapidly set to form the round shaped particles, mostly spherical. The round particles may be hollow or porous, or solids depending on the target particle densities and end applications. Heat may be utilized in some cases to facilitate setting and removing any access liquid by evaporation. The particle setting occurs before, during and after presence of the liquid precursor in the particle setting equipment. The particle forming chamber is preferably under negative pressure to control dust and exhaust any evaporative vapors that may generate during the forming process. It is possible to control the chamber gas composition by injecting for example steam or carbon dioxide during the particle formation process. Likewise, water can be introduced as a mist to control the temperature and humidity of the chamber. Forming equipment could be a micro pelletizers such as a pin mixer or a fluidizer, or alike. The scope of the invention is not limited by the type of the particle forming equipment employed. The plurality of shaped particles are collected and removed from the forming equipment. One modality is to remove the particles from the bottom of the sprayer unit, and another option is to collect the particles upstream in a dust collecting system, such as a bag house.

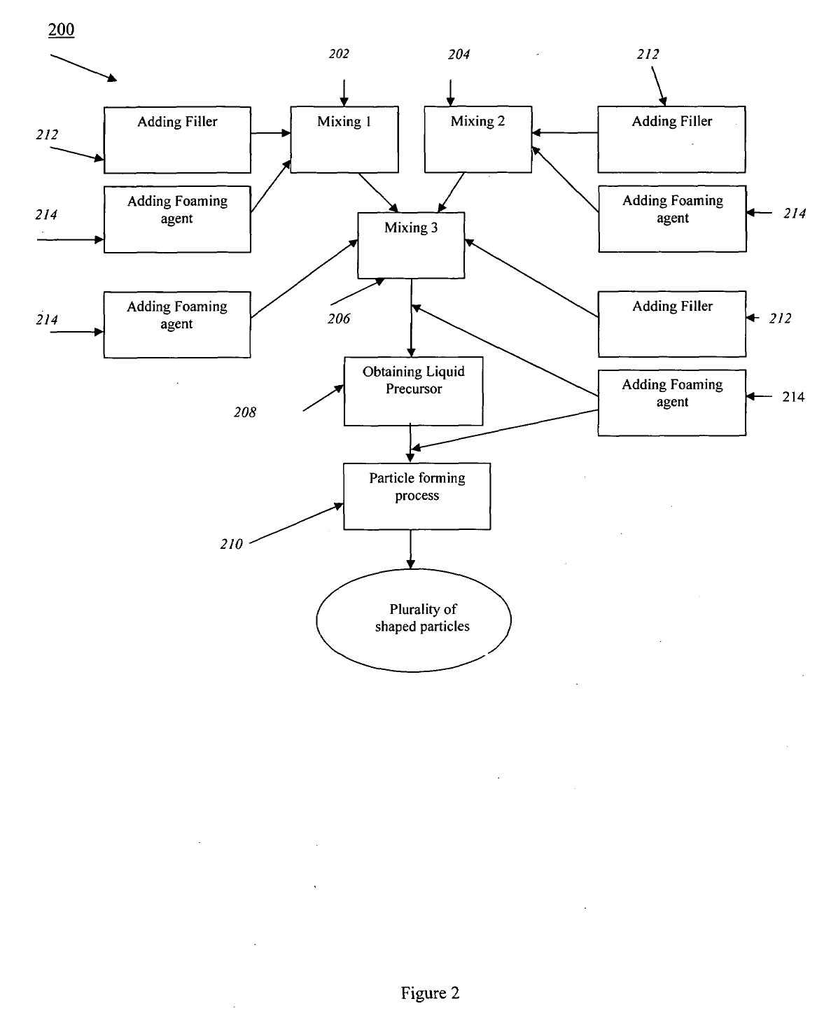

FIG. 2 represents a flowchart of a first exemplary method of manufacturing a plurality of shaped particles shaped particles, in accordance with an aspect of the present invention.

According to the manufacturing method 200 represented in FIG. 2, the following processing steps are carried out during the manufacturing of the plurality shaped particles: in step 202 a liquid precursor comprising at least one settable compound is formed. The liquid portion of the settable compound is batched according to the composition method of the present invention as it will be described further in this document. If the liquid components of the liquid precursor are more than one, then the components are preferably mixed in step 202. In addition, the batched settable compounds are added into the liquid precursor. In step 204, the solid portion of the settable compound is batched. This is an optional step, since the components of the settable compound can exist in liquid form. If there is more than one solid component in the formulation of the settable compound, solid components are preferably blended-in in step 204. In step 206, the solid and liquid components of the settable compound are blended together to form the liquid precursor. If there are no solid components in the formulation, then step 206 is skipped and the method proceeds with the mixture obtained in step 202. In step 208, the liquid precursor is processed into the plurality of shaped particles, and the solid shaped particles are formed. Filler materials, admixtures, and foaming agents may be added and blended in either step of 202, 204, 206. The step of adding a foaming agent, 214, or adding an admixture 213, may also occur in additional discrete or combined steps 212, 213, and 214 between the steps 206 and 208. Filler materials can also be added between the steps 206, and 208, but preferably to either step 202, or 204, or a combination thereof. Solid filler materials, solid admixtures, and solid foaming agents are preferably added to the solid components of the settable compound in step 104. In one embodiment of the present method, water and optionally foaming agent(s) and admixture(s) are batched and blended in step 204. The following described example illustrates the steps of producing a plurality of shaped particles from a magnesium based settable compound. In this embodiment of the present invention the end product is a plurality of magnesium oxychloride shaped particles. A magnesium chloride solution is prepared by mixing MgCl2.6H2O solids with water to obtain a solution with an approximate density between 20-30 Be (Baume). Alternatively, concentrated MgCl2 solutions can be diluted with water to obtain the targeted density. Optionally, the mixing step can comprise the addition to the liquid mixture of a foaming agent, which is added to the magnesium chloride solution, such as, hydrolyzed proteins, saponin, or other foaming agents previously mentioned in the present document, or optionally other commercially available synthetic or natural foaming agent. The mixing step can be accomplished mechanically by agitation to produce a foamy liquid. Optionally, the mixing step might also involve the addition of surfactants to stabilize the foamy liquid. Additionally, other liquid filler materials can also be added in step 202. If filler materials are to be added further in the process, such as in step 206, then the filler materials may also be solids, liquids, gels, solutions, or slurries. Acids are advantageous to be added to the magnesium chloride or sulfate solutions. Low addition levels less than 10% by weight, result in shaped particles that have a better chemical durability. The magnesium oxide is batched like in step 204, and the components are mixed in step 206.

In another example, the end product of the manufacturing a plurality of shaped particles process is a plurality of magnesium phosphate shaped particles. In step 202 a solution is prepared from either one of ammonium phosphates, or alkali phosphates, or combination thereof, in water. Mixing step 202 is carried out in any conventional mixer, such as in agitated tanks, in-line mixers, intensive mixers, high shear mixers, concrete and grout mixers, wet mill, and alike. Set admixtures may be added to control the set time and pot life of the phosphate precursors. Magnesium oxide is batched in step 204. Finer MgO powders, e.g. of −400 mesh are more reactive than the coarser grade of −325 mesh. Also, dead burned MgO is less reactive than light burned MgO. Therefore, depending on the desired reactivity a variation is elected.

Step 204 is optional, and is carried out if solid components of the settable compound are to be mixed before the formation of the liquid precursor, but water should not be added to MgO before the addition of MgCl2 solution or alkali phosphate solution before the step 206, where the components of the settable compounds are mixed and ready to be processed into shaped particles. Mixing step 202 can be utilized to form the precursor without needing the optional step 204. In step 204 of the process the mixing of the solid components optionally takes place prior to the addition to the liquid portion formed in step 202. Step 204 might involve only a single solid component, such as, magnesium oxide or a plurality of components. Optionally solid foaming agents and solid filler materials can be mixed with the magnesium oxide in step 204. Admixtures also can be added in step 204. Mixing is accomplished by any conventional solid mixing techniques, such as dry ball milling, v-blenders, stirred mills, agitation, tumbling, paddle and ribbon blenders, and alike. When shaped particles are to be made from calcium sulfo aluminate, or any other single settable compound that requires water to set, step 204 involves mixing the single component of the settable calcium sulfo aluminate compound, and other solid components including solid fillers, solid foaming agents, and solid admixtures. The liquid phase mixed in step 202 comprises primarily water mixed with optional liquid or solid fillers, liquid or solid admixtures and liquid or solid foaming agents. Optionally, solid components of the settable compounds according to the method of the present invention maybe blended with other solid additives, fillers, foaming agents, and admixtures in step 204. The preferred settable compounds are magnesium oxy chloride, magnesium oxy sulfate, magnesium phosphate, calcium phosphate, calcium sulfo aluminate, calcium aluminates, alkali activated alumina silicates, and pozzolanic cementitious materials. In the case of calcium sulfo aluminate the major rapid setting component 4CaO.3Al2O3.SO3 may be blended with fine grind Portland cement to improve economy and control the set time. In the case of phosphate cements, zinc oxide, or calcium oxide, may partially or wholly replace magnesium oxide. In the case of magnesium oxy chloride, magnesium oxide is blended with magnesium chloride crystals and other solids in step 204 to form a dry pre-blend precursor. Water is then added in step 206 to form the liquid precursor which is then processed into settable shaped particles.

The end product of mixing step 202, and mixing step 204 are further mixed together at mixing step 206, into liquid precursor containing the components of the settable compounds. In step 206 mixing is accomplished in an agitated tank, high intensity mixture, shear mixer, pin mixer, vertical stirred mill, in-line mixer, a secondary chamber mixer and alike. Optionally, foaming agents and filler materials can be added to the precursor obtained in step 206. The liquid precursor resulting after mixing step 206 is ready to be formed into shaped particles. In step 214 a foaming agent can be optionally blended with the liquid precursor just prior to the formation of the shaped particles. This can be accomplished by an in-line mixer, a secondary chamber mixer, and alike. In one example of the present invention, the ratio of MgO to magnesium chloride solution (20-30 Be) can vary from 2:1 to 1:2 depending on the filler loading and set time.

The shaped particle forming step 208 is carried out in a particle forming equipment such as a thermal sprayer, a spray dryer, a fluidized bed, a pelletizer, a pin mixer, an extruder, a droplet former, a furnace, a calciner, and alike. The shaped particle forming temperature may vary from sub ambient to elevated temperatures, as needed. The residence time at the forming step 208 can also vary from seconds to minutes. Optionally additional materials can be added or applied to the particle forming step of 208 while the shaped particles are being formed or after they are formed. For example, additional compounds can be applied as coating materials by co-spraying in the thermal spraying unit to form coated shaped particles. The plurality of shaped particles is harvested from the device used to accomplish step 208, cooled if necessary, and stored.

In one embodiment of the present invention, while the foaming agent is eliminated all together, the practice of method 200 leads to the manufacture of substantially solid shaped particles. This is a preferred method of generating the shaped particles if extremely high strength particles are sought. Also, in the case of projected use of such particles for toxic and radioactive waste encapsulation, entirely solid particles represent a better choice than foamed, porous, and hollow particles due to lower surface area per volume of particles.

The novel plurality of shaped particles fabricated by a process of manufacture like the one described above and using preferred settable compounds, finds a plurality of uses in composite materials, imparting processing aid as well as improved properties to the composite materials.

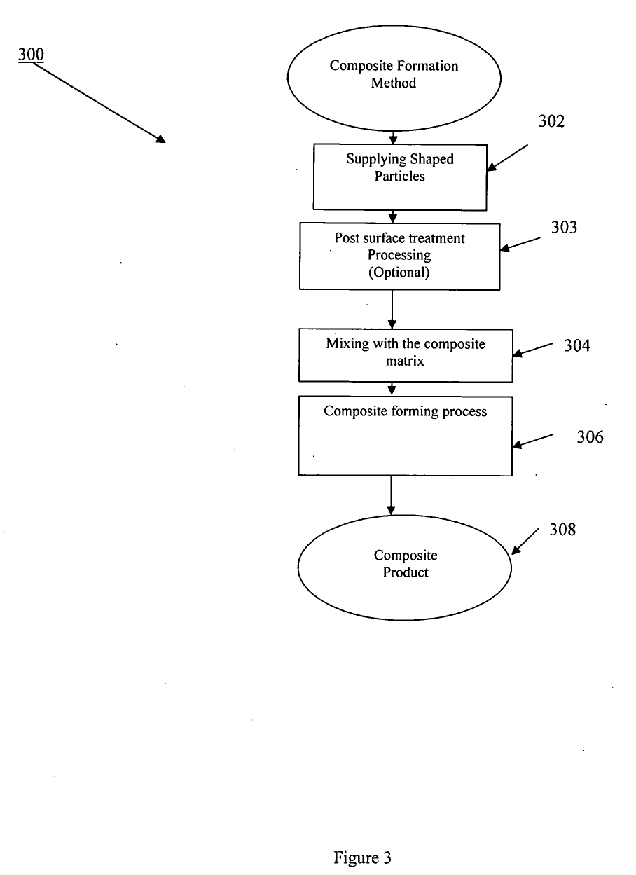

FIG. 3 represents a flowchart of a composite formation method, in accordance with another aspect of the present invention.

the composite formation method 300 comprises a forming step 302, during which a plurality of early strength shaped particles are supplied. The shaped particles may require additional processing steps prior to becoming suitable for use in composite applications, therefore optional post treatment processing steps might be necessary to be performed in methods 100 and 200. Optionally, a surface treatment step 303 to alter or modify the surface properties of the particles may be advantageous towards providing a stronger bond between the shaped particles and the composite matrix. Such stronger bond leads to better overall mechanical properties of the final composite material. For example, if use of the shaped particles is intended in polymeric composites, a coupling agent for bonding organic polymers to inorganic surface using silicon functional termination groups is highly advantageous. Organofunctional silanes are the best known coupling agents, for example DuPont Fusabond® coupling agent is a commercial product designed specifically to provide strong bond between inorganic particles in polypropylene matrix composites. In specialized applications, the shaped particles may be subjected to additional processes 303 in which oxide or metallic surface coatings are formed for special applications. Examples are metal coating for metal matrix composites, and protective coating against chemical attacks. In some applications, the particles may be subjected to more than one post treatment processing.

In a subsequent step 304, the shaped particles are mixed with the desired composite matrix materials to form low carbon foot print products such as green building products, and green composites. In cementitious or concrete composite applications, mixing 304 is mixing the plurality of particles with the cement or concrete slurry by conventional means such as batch mixers, extruders, pug mills, etc. In the case of polymeric composites, the mixing may be carried out by kneading, cold and hot extrusion, and other conventional means that are known to persons skilled in polymeric mixing techniques. Shaped particles are appropriate to also use in both thermoplastics and thermo set plastics.

In a subsequent step 306, the composite forming process occurs by extrusion, pultrusion, and hatcheck process, paper forming process, pressing, molding, casting, and other conventional techniques that are used in various industries. The composites according to the inventive embodiment of the present invention contain the plurality of shaped particles securely attached to a matrix.

There are many advantages associated with the use of the shaped particles in composite products. They include low carbon foot print, environmentally friendly by reuse of waste byproducts that otherwise are land filled such as fly ash, kiln dust, and gypsum sludge from acid gas scrubbers, to name just a few. The inventive method of manufacturing shaped particles from settable compounds is simple, requires low energy, and provides high throughput at a low cost. The capital equipment cost is by far much lower than for example capital cost of a plant making shaped glass particles. The shaped particles of the present invention are chemically durable and physically strong, thus a prime choice for making high performance composite products such as low weight high strength building products. The low density shaped particles of the present invention when added to the building products, lowers the composite density of the building products, yet does not degrades the mechanical strength of the composite as much as air entrainment alone would do. Thus, the specific strength of the composite which is defined as the mechanical strength divided by the composite density is greatly improved, and is substantially higher than specific strength of an equal density composite where the density is lowered by air entrainment. In certain building materials such as exterior cladding and roofing products, the shaped particles improve freeze-thaw, wet-dry durability, and dimensional stability, extending the service life of the composite building products. In polymeric composites, the shaped particles can greatly improve mechanical strength and ware resistant of the polymeric matrix. In cement slurries, the round shaped particles can greatly improve the rheological of the slurry and strength of the hardened cement, such as application in oil wells. Spherical shaped particles according to the present invention has great utility in improving application and performance in paints and coatings. This is by improving the rheology during the application and toughness of the paints and coatings after application and curing on the job. Therefore, porous or hollow shaped particles according to the present invention are the excellent choice to improve physical properties of the composites comprising building materials, cementitious products, and polymeric composites. In certain applications, the shaped particles with or without the post treatment, will improve the internal chemical bonding strength of the composites materials, thus improving the stability and service life of the resulting composites. In some cases, the surface chemistry of the shaped particles is such that it improves the curing process of the composites, such as more efficient degree of polymerization in polymers and rapid setting of the cementitious composites, thus improving overall quality and manufacturing efficiency. Further, the lubricating effect of round shaped particles by being free flowing and rolling, assists in the forming and shaping during manufacturing of the composite products. By using waste products and by products in the manufacturing of shaped particles of the present invention, not only a highly added product is realized, but the waste disposal burden on the environment is reduced. Thus, the resulting composites utilizing the shaped particles have a positive impact on the environmental stewardship. Thus, the shaped particles of the present invention impart improved physical, chemical, and environmental performance of composites.

Additional objects, advantages and novel features of the invention as set fourth in the invention will be apparent to one skilled in the art after reading the foregoing detailed description or may be learned by practicing the invention. The objects and advantages of the invention may be realized and attained by means of instruments and combinations described and particularly pointed out here.

What I claim is:

1. A plurality of shaped particles, comprising:
at least one shaped early mechanically strong particle,
wherein said plurality of particles comprises a plurality of settable compounds.

2. The plurality of shaped particles of claim 1, wherein said shaped early mechanically strong particles is at least one of solid, porous, hollow, or a combination thereof.

3. The plurality of shaped particles of claim 1, wherein said shaped early mechanically strong particles is at least one of round and elongated.

4. The plurality of shaped particles of claim 1, wherein said plurality of settable compounds comprises at least a rapid set compound.

5. The plurality of shaped particles of claim 1, wherein said plurality of settable compounds comprises a combination two distinct components.

6. A method of manufacturing a plurality of shaped particles, comprising:
forming a liquid precursor comprising at least one settable compound, and
processing said liquid precursor into said plurality of shaped particles.

7. The method of claim 6, wherein said liquid precursor is at least one of a solution, a paste, a slurry, a suspension, a gel, and combination thereof.

8. The method of claim 7, wherein said precursor is at least one of aqueous, non aqueous, and combination thereof.

9. The method of claim 7, further comprising setting of said at least one settable compound by at least one of a chemical reaction, crystallization, hydration, physical combination, gelation, dehydration, drying, and a combination thereof.

10. The method of claim 9, wherein said setting of said at least one settable compound occurs prior, during, post forming and a combination thereof the processing of said liquid precursor into said plurality of shaped particles.

11. The method of claim 7, wherein the method further comprises post processing steps of said plurality of shaped particles.

12. The method of claim 7, wherein said at least one settable compound is a rapid setting compound elected from a plurality comprising at least one of magnesium containing compound, phosphate containing compound, calcium containing compound, aluminate containing compound, alkali activated alumino silicate containing compound, and calcium sulfo-aluminate containing compound.

13. The method of claim 6, wherein said setting processing requires low to negative energy input.

14. The method of claim 6, wherein said processing step is one of thermal spraying, spray drying, pelletizing, extruding, fluidizing, and pulverizing a bulk of settable compound.

15. A composition of a plurality of shaped particles, comprising:
at least one settable compound in a liquid medium.

16. The composition of claim 15, wherein said at least one settable compound comprises at least one of a compound of an alkaline earth element, a compound of phosphate, a compound of chloride, a compound of sulfate, a compound of silicate, a compound of aluminate, a compound of alumino-silicate, a compound of alumina, a compound of an alkali metal, water, and a combination thereof.

17. The composition of claim 15, further comprising fillers such as waste byproducts.

18. A composite, comprising:
a plurality of shaped particles,
wherein said composite possesses improved physical, chemical, and environmental performance.

19. The composite of claim 18, wherein the composite is a building product, a polymeric product, a cementitious product, a cement slurry, a paint, and a coating.

20. The composite of claim 18, wherein the addition of shaped particles improves the specific strength, manufacturing efficiency, and service performance of the resulting composites.
